(19) United States
(12) Patent Application Publication
(10) Pub. No.: US 2005/0237995 A1
(43) Pub. Date: Oct. 27, 2005

(54) Method and system for providing time information via a wireless network

(76) Inventor: Gagan Puranik, Madison, MS (US)

Correspondence Address: MCI, INC, 1133 19TH STREET NW, WASHINGTON, DC, 20036, US

(21) Appl. No.: 10/830,002

(22) Filed: Apr. 23, 2004

(51) Int. Cl. H04Q 7/20

(52) U.S. Cl. 370/350

(57) ABSTRACT

A method for providing time information to user devices in a wireless network includes configuring transmitters in the wireless network based on the time zone in which they are located. Each transmitter may then transmit a frame, such as a synchronization frame, that includes information that may be used by a user device to identify a time zone in which the user device is located.

### FIELD OF THE INVENTION

The present invention relates to networks and, more particularly, to providing time information via a wireless network.

### BACKGROUND OF THE INVENTION

Wireless networks provide subscribers with the ability to transmit and receive information over the air. For example, the ReFLEX protocol is a conventional messaging protocol used to deliver control and data messages to subscriber devices in a wireless network. According to the ReFLEX protocol, messages may be transmitted to subscriber units on a forward channel. Acknowledgement messages from the subscriber units may be received on a reverse channel.

Systems operating in accordance with the ReFLEX protocol often broadcast time information, such as Coordinated Universal Time (UTC), to subscriber units to support customer applications. For example, the UTC information may be needed to perform time synchronization. In some cases, local time information may also be needed by subscriber units to support various customer applications.

### SUMMARY OF THE INVENTION

There exists a need for systems and methods that provide local time information to user devices in wireless networks.

According to one aspect of the invention, a method for providing time information to user devices via a wireless network is provided. The method includes configuring a number of transmitters in the wireless network such that a synchronization frame transmitted by each of the transmitters may be used by the user devices to identify time zone information. The method also includes transmitting, by each of the transmitters, the synchronization frame via the wireless network.

According to another aspect of the invention, a system including a plurality of transmitters is provided. Each of the transmitters is configured to insert information in a synchronization frame, the information corresponding to a time zone associated with the respective transmitter. Each of the transmitters is also configured to transmit the synchronization frame via a wireless network.

Another aspect of the invention provides a device that includes a receiver and logic. The receiver is configured to receive radio frequency (RF) signals from a transmitter, where the RF signals include a synchronization signal. The logic is configured to decode the synchronization signal and identify a time zone in which the device is located based on the decoded synchronization signal.

A further aspect of the invention includes a method for providing time information to user devices via a wireless network. The method includes configuring each of a number of transmitters to transmit identification information based on a time zone in which each respective transmitter is located. The method also includes transmitting a frame including the identification information from each of the transmitters via the wireless network.

Other features and advantages of the invention will become readily apparent to those skilled in this art from the following detailed description. The embodiments shown and described provide illustration of the best mode contemplated for carrying out the invention. The invention is capable of modifications in various obvious respects, all without departing from the invention. Accordingly, the drawings are to be regarded as illustrative in nature, and not as restrictive.

### BRIEF DESCRIPTION OF THE DRAWINGS

Reference is made to the attached drawings, wherein elements having the same reference number designation may represent like elements throughout.

FIG. 1 is a block diagram of an exemplary system in which methods and systems consistent with the invention may be implemented.

FIG. 2 is a block diagram illustrating an exemplary configuration of a user device of FIG. 1 in an implementation consistent with the invention.

FIG. 3 is a block diagram illustrating an exemplary configuration of the network operations center of FIG. 1 in an implementation consistent with the invention.

FIG. 4 illustrates an exemplary synchronization signal transmitted in accordance with the ReFLEX protocol.

FIG. 5 illustrates an exemplary portion of the wireless network of FIG. 1 in an implementation consistent with the invention.

FIG. 6 is an exemplary flow diagram associated with generating local time information in an implementation consistent with the invention.

### DETAILED DESCRIPTION

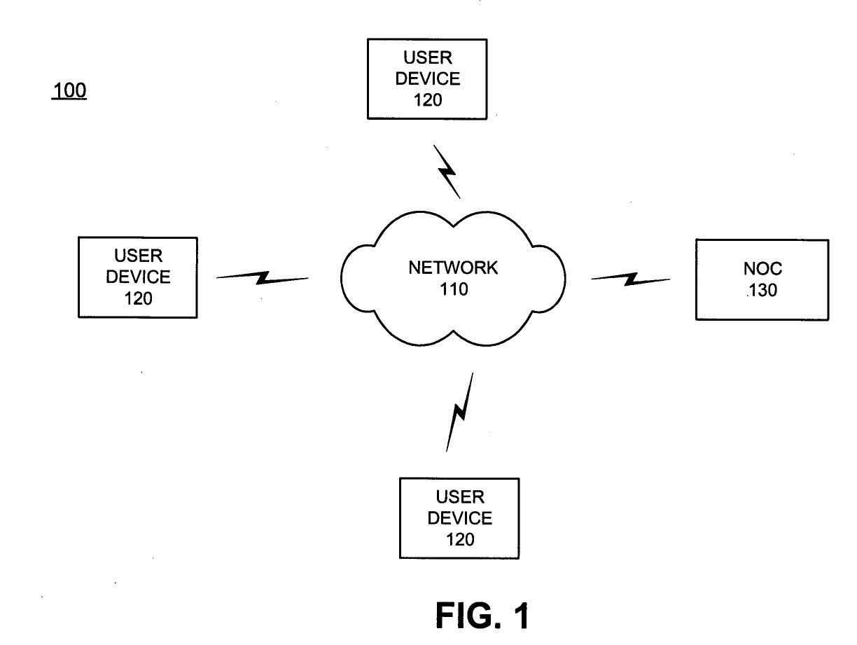

FIG. 1 is a block diagram of an exemplary system 100 in which methods and systems consistent with the invention may be implemented. System 100 may include network 110, user device 120 and a network operations center (NOC) 130. The exemplary configuration illustrated in FIG. 1 is provided for simplicity. It should be understood that a typical system may include more or fewer devices than illustrated in FIG. 1. For example, three user devices 120 are illustrated in FIG. 1. It should be understood, however, that system 100 may include more or fewer user devices 120.

Network 110 may include one or more wireless networks, as well as a wired or optical network. In one implementation, network 110 may include conventional components for transmitting/receiving data to/from a number of user devices 120. For example, network 110 may include a number of base stations, transmitters and transmission towers for receiving radio frequency (RF) signals and forwarding the RF signals toward their intended destination, as described in more detail below. In one implementation, network 110 may transmit RF signals in accordance with the ReFLEX protocol.

User device 120 may include a device that is able to receive data and/or voice signals from a wireless network, such as network 110. For example, user device 120 may include any wireless device, such as a radiotelephone with or without a multi-line display; a personal communications system (PCS) terminal that may combine a cellular radiotelephone with data processing, facsimile and data communications capabilities; a personal digital assistant (PDA) that may include a radiotelephone, a pager, an Internet/intranet access, a Web browser, an organizer, a calendar and/or a global positioning system (GPS); or a conventional laptop and/or palmtop receiver or other appliance that includes a wireless transceiver. In one implementation, user device 120 may be configured to operate in accordance with the ReFLEX protocol.

NOC 130 may include any type of computer system, such as a mainframe, minicomputer, personal computer, laptop, PDA, etc., that provides services associated with transmitting and receiving data via network 110. In one implementation, NOC 130 may represent an entity that provides wireless services to customers, such as customers associated with user devices 120. These services may include, for example, two-way messaging, one-way messaging, wireless e-mail, fleet tracking, etc.

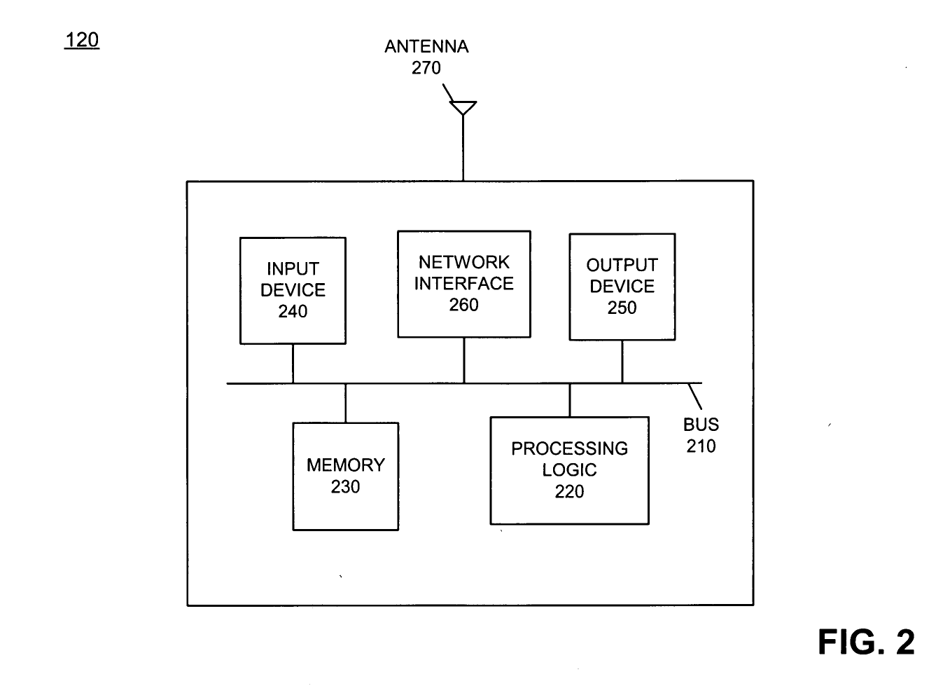

FIG. 2 is block diagram illustrating an exemplary configuration of user device 120 in an implementation consistent with the invention. Referring to FIG. 2, user device 120 may include a bus 210, processing logic 220, a memory 230, an input device 240, an output device 250, a network interface 260 and an antenna 270. It should be understood that user device 120 may include other components (not shown) that aid in receiving, transmitting, and/or processing data.

Bus 210 may include a conventional bus that allows communication among the components of user device 120. Processing logic 220 may include any type of conventional processor or microprocessor that interprets and executes instructions. In other implementations, processing logic 220 may be implemented as an application specific integrated circuit (ASIC), field programmable gate array (FPGA), or the like. Memory 230 may include a random access memory (RAM) or another type of dynamic storage device that stores information and instructions for execution by processing logic 220; a read only memory (ROM) or another type of static storage device that stores static information and instructions for use by processing logic 220; and/or some type of magnetic or optical recording medium and its corresponding drive.

Input device 240 may include a conventional device that permits a user to input information to user device 120, such as a keyboard, a keypad, a mouse, a pen, a microphone, one or more biometric mechanisms, etc. Output device 250 may include a conventional device that outputs information to the user, including a display, a printer, a speaker, etc.

Network interface 260 may include any transceiver-like mechanism that enables user device 120 to communicate via network 110. In one implementation, network interface 260 may include a transceiver or transmitter/receiver pair capable of transmitting and receiving data in accordance with the ReFLEX protocol. Antenna 270 may include any directional, multi-directional, or omni-directional antenna or antenna array.

User device 120 may implement the functions described below in response to processing logic 220 executing software instructions contained in a computer-readable medium, such as memory 230. A computer-readable medium may be defined as one or more memory devices and/or carrier waves. In alternative embodiments, hardwired circuitry may be used in place of or in combination with software instructions to implement features consistent with the principles of the invention. Thus, implementations consistent with the invention are not limited to any specific combination of hardware circuitry and software.

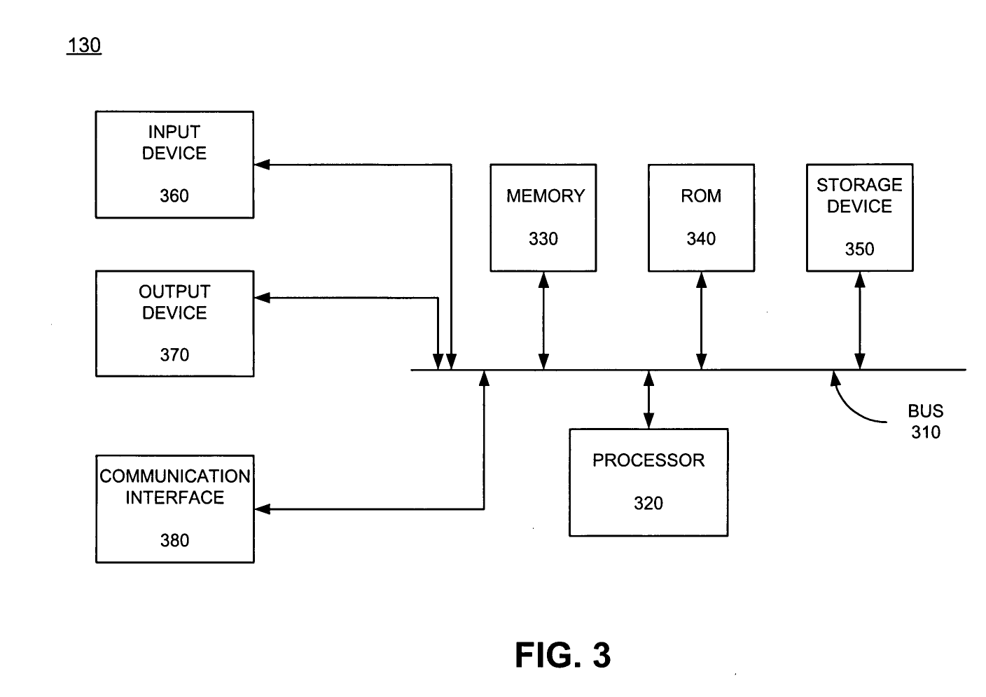

FIG. 3 is a block diagram illustrating an exemplary configuration of NOC 130 of FIG. 1. Referring to FIG. 3, NOC 130 may include a bus 310, a processor 320, a memory 330, a ROM 340, a storage device 350, an input device 360, an output device 370, and a communication interface 380. Bus 310 permits communication among the components of NOC 130.

Processor 320 may include any type of conventional processor or microprocessor that interprets and executes instructions. Processor 320 may also be implemented as one or more ASICs, FPGAs, etc. Memory 330 may include a RAM or another dynamic storage device that stores information and instructions for execution by processor 320. Memory 330 may also be used to store temporary variables or other intermediate information during execution of instructions by processor 320.

ROM 340 may include a conventional ROM device and/or another static storage device that stores static information and instructions for processor 320. Storage device 350 may include a magnetic disk or optical disk and its corresponding drive and/or some other type of magnetic or optical recording medium and its corresponding drive for storing information and instructions.

Input device 360 may include a conventional mechanism that permits a user to input information to NOC 130, such as a keyboard, a mouse, a pen, voice recognition and/or biometric mechanisms, etc. Output device 370 may include a conventional mechanism that outputs information to the user, including a display, a printer, one or more speakers, etc.

Communication interface 380 may include any transceiver-like mechanism that enables NOC 130 to communicate with other devices and/or systems. For example, communication interface 380 may include a transceiver (or transmitter/receiver pair) and an antenna for communicating via a wireless network, such as network 110. Communication interface 380 may also include mechanisms, such as a modem or an Ethernet interface, for communicating via a LAN or another type of network.

NOC 130, consistent with the present invention, provides a platform through which services may be provided to user devices 120. According to an exemplary implementation, NOC 130 performs processing associated with providing these services in response to processor 320 executing sequences of instructions contained in memory 330. Such instructions may be read into memory 330 from another computer-readable medium, such as storage device 350, or from a separate device via communication interface 380. Execution of the sequences of instructions contained in memory 330 causes processor 320 to perform the acts that will be described hereafter. In alternative embodiments, hard-wired circuitry may be used in place of or in combination with software instructions to implement the present invention. Thus, implementations consistent with the invention are not limited to any specific combination of hardware circuitry and software.

As discussed above, in an exemplary implementation, network 110 may represent a wireless network operating in accordance with the ReFLEX protocol. In the ReFLEX protocol, a synchronization signal may be transmitted to devices to enable the devices (e.g., user devices 120) to obtain frame timing.

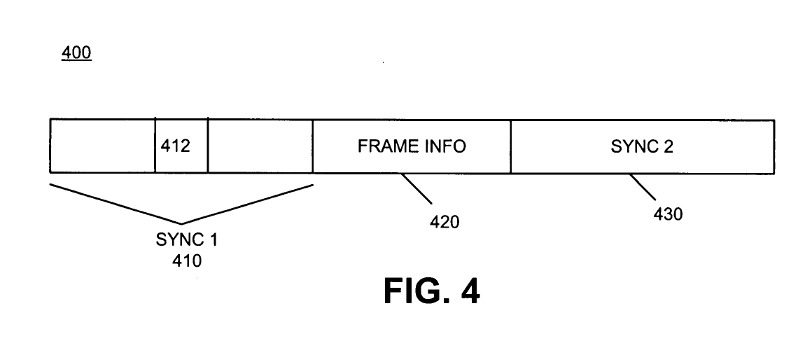

For example, FIG. 4 illustrates an exemplary synchronization signal transmitted in accordance with the ReFLEX protocol. Referring to FIG. 4, signal 400 includes a sync 1 field 410, a frame information field 420 and a sync 2 field 430. Signal 400 may be transmitted at the beginning of a frame that includes a number of data blocks (not shown). Sync 1 field 410 enables user device 120 to obtain frame timing and indicates the data rate for the remainder of the frame. Sync 1 field 410 may include a ‘B’ bit field 412, described in more detail below. Frame information field 420 may include the frame and cycle number and may include a number of flags that identify the control frame type. Sync 2 field 430 may provide information to allow user devices 120 to demultiplex and decode the blocks in the frame.

In accordance with conventional ReFLEX protocol, B bit field 412 is a 16 bit field that includes color code information identifying one of 128 different color codes. For example, in a ReFLEX system, each transmitter in a particular coverage zone may be assigned a color code. The color codes may be used to facilitate registration of user devices 120. For example, the value in B bit field 412 may vary based on the particular coverage zone/area of the transmitter transmitting signal 400. That is, NOC 130 may signal one or more base stations/transmitters to transmit sync signal 400 to user devices 120. Based on the location of the particular transmitters, the value in B bit field 412 may vary.

User devices 120 may store index values ranging from 0-127 corresponding to the 128 possible values of the B bit field 412. When sync signal 400 is received, each user device 120 decodes the information in B bit field 412 and identifies the corresponding color code index. When NOC 130 transmits a system location query to user devices 120, each user device 120 responds with the color code index value that it identified based on B bit field 412. In this manner, NOC 130 is able to track the location of user devices 120.

Implementations consistent with the invention use B bit field 412 to convey local time information, as described in more detail below. The user devices 120 may then use the local time information for particular applications requiring local time.

As discussed above, conventional ReFLEX systems use 128 different color codes transmitted in 16-bit B bit field 412. User devices 120 store the 128 possible B bit color code patterns and corresponding color code indices in memory (e.g., memory 230) and identify the color code index based on the value in B bit field 412. For example, a transmitter may transmit the following information in B field 412: 0001110111110000. User device 120 may store a table indicating that this bit pattern corresponds to an index value of 16, in accordance with the ReFLEX protocol. User device 120 may store B bit color code patterns and corresponding index numbers for each of the other 127 color codes used in ReFLEX-based systems. When a transmitter transmits a particular color code in B bit field 412, user device 120 may use the color code to do a lookup to identify the corresponding color code index.

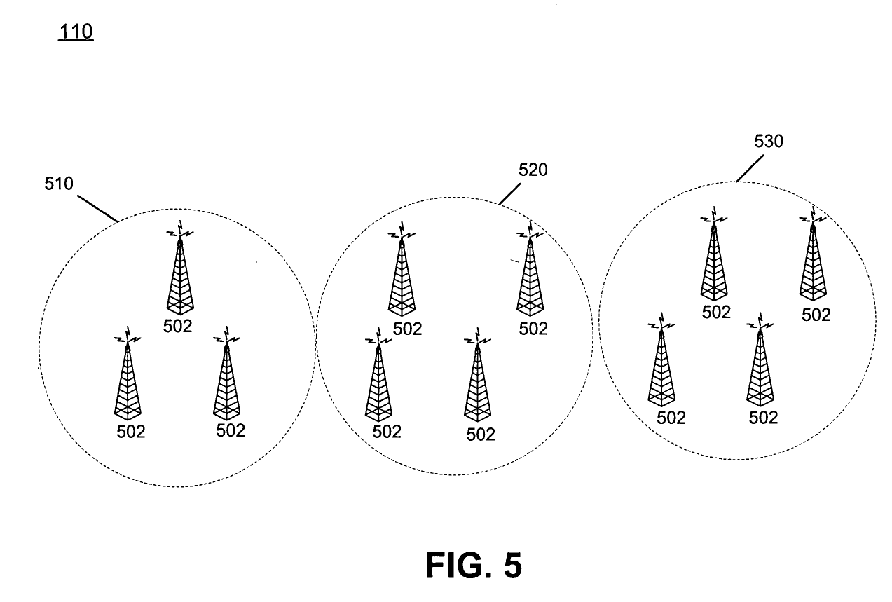

In accordance with implementations of the invention, the transmitters used by system 100 may be configured such that their corresponding color code indices identify the time zone in which they are located. For example, FIG. 5 illustrates a portion of network 110 consistent with the invention. Referring to FIG. 5, network 110 may include a number of transmitters 502 located in each of zones 510, 520 and 530. Each of zones 510-530 may represent a particular time zone. For example, zone 510 may represent the Mountain time zone, zone 520 may represent the Central time zone and zone 530 may represent the Eastern time zone. In accordance with an exemplary implementation, transmitters 502 in each particular zone may be configured such that the color code they transmit in B bit field 412 corresponds to an index that may be mapped to indicate the time zone in which they are located.

For example, Table 1 below illustrates time zone information associated with color code indices according to an exemplary implementation of the invention.

TABLE 1

| | BIT PATTERNS | |
|---|---|---|
| COLOR CODE | ASSOCIATED WITH | |
| INDICES | COLOR CODE INDICES | TIME ZONE |
| 0-15 | 000XXXX | Reserved |
| 16-31 | 001XXXX | Eastern Time |
| 32-47 | 010XXXX | Central Time |
| 48-63 | 011XXXX | Mountain Time |
| 64-79 | 100XXXX | Pacific Time |
| 80-95 | 101XXXX | Eastern Indiana |
| 96-111 | 110XXXX | Arizona |
| 112-115 | 11100XX | Hawaii; |
| 116-119 | 11101XX | Alaska; |
| 120-123 | 11110XX | Aleutian Islands; and |
| 124-127 | 11111XX | Reserved |

Referring to Table 1, color code indices ranging from 16-31 (e.g., 001XXXX in binary representation) may be associated with the Eastern time zone, color code indices ranging from 32-47 (010XXXX) maybe associated with the Central time zone, color code indices ranging from 48-63 (e.g., 011XXX) may be associated with the Mountain time zone, color code indices ranging from 64-79 (100XXXX) may be associated with the Pacific time zone bit, color code indices ranging from 80-95 (101XXXX) may be associated with the Eastern Indiana time zone and color code indices ranging from 96-111 (110XXXX) may be associated with the Arizona time zone. In addition, color code indices ranging from 112-115 (11100XX) may be associated with the Hawaii time zone, color code indices ranging from 116-119 (11101XX) may be associated with the Alaska time zone and color code indices ranging from 120-123 (11110XX) may be associated with the Aleutian Islands time zone. Color code indices ranging from 0-15 (000XXXX) and 124-127 (11111XX) may be reserved for future use. It should be understood that other color code indices may be used to represent these or other time zones.

For example, if the ReFLEX system was implemented in Europe or Asia, the color code indices would correspond to time zones in those particular regions. In each case, user devices 120 may be configured to recognize which color code indices represent which particular time zones.

In addition, the particular transmitters (e.g., transmitters 502) in each time zone are configured such that they transmit color code information that may be mapped by user devices 120 to indicate the appropriate time zone in which they are located. That is, each user device 120 stores a table that maps the color code transmitted in B bit field 412 to a color code index. Each user device 120 may also store a table (e.g., Table 1 above) that maps the color code index to time zone information. It should be understood that user device 120 may store the color code values, color code indices and time zone information in a single table.

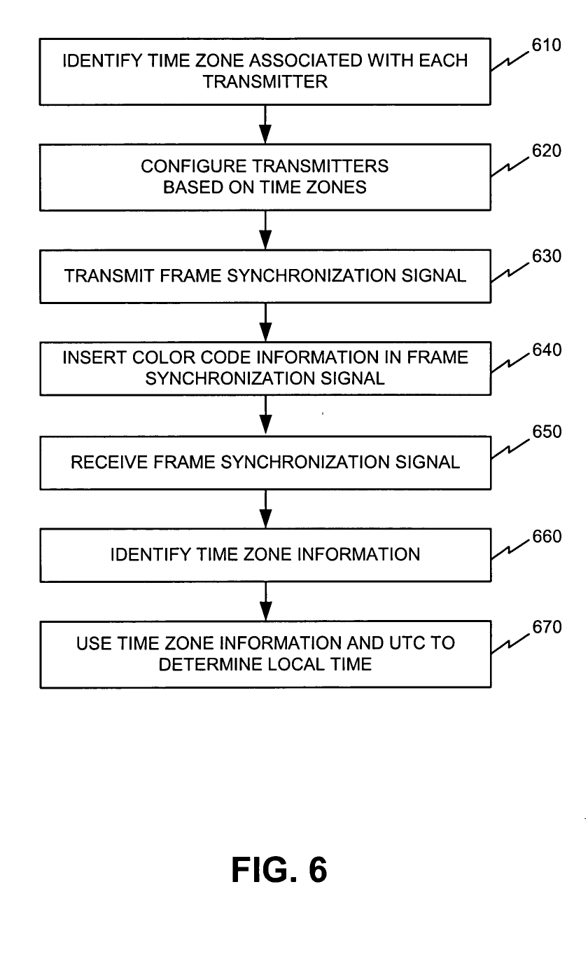

FIG. 6 illustrates exemplary processing associated with generating local time information in an implementation consistent with the invention. Processing may begin with NOC 130 or a party associated with NOC 130 identifying the time zones associated with each particular transmitter 502 in network 110 (act 610). That is, NOC 130 or a party associated with NOC 130 may identify the time zone in which each transmitter 502 (or group of transmitters 502) is located.

NOC 130 may then configure each transmitter 502 (or group of transmitters) in network 110 based on its particular time zone. For example, NOC 130 may configure each transmitter 502 so that the transmitter 502 will transmit color code information that corresponds to the color code indices in Table 1 above (act 620). Alternatively, each transmitter 502 in network 110 may be configured locally such that the transmitter 502 stores the appropriate color code information and insert the appropriate color code information in B bit field 412 when transmitting a synchronization signal.

For example, assume that zone 530 (FIG. 5) corresponds to the Eastern time zone. In this case, transmitters 502 in zone 530 may be configured such that their corresponding color code indices range from 16-31, as illustrated in Table 1 above. Similarly, if transmitters 502 in zone 520 are located in the Central time zone, these transmitters may be configured such that their corresponding color code indices range from 32-47.

Assume that NOC 130 transmits a frame synchronization signal 400 via network 110 (act 630). As discussed above, the frame synchronization signal 400 may be used to allow user devices 120 to perform timing synchronization. Each transmitter 502 receives the frame synchronization signal, identifies its particular color code information (i.e., B bit value) and inserts the color code information in B bit field 412 of frame synchronization signal 400 (act 640). That is, if a particular transmitter 502 is in the Eastern time zone, that transmitter 502 may be configured to transmit a synchronization signal 400 in which the corresponding color code index ranges from 16-31. Each other transmitter 502 in network 110 may perform a similar process and transmit frame synchronization signal 400 with its particular color code value in B bit field 412.

Each user device 120 may receive the frame synchronization signal 400 from its nearest transmitter 502 (act 650). Each user device 120 may then decode B bit field 412 to identify the corresponding time zone information (act 660). For instance, in the example above in which the transmitter 502 nearest user device 120 is in the Eastern time zone, user device 120 may decode B bit field 412 and identify that the corresponding color code index is, for example, 28. User device 120 may then perform a lookup of time zones stored in its memory (e.g., memory 230) and determine that color code index 28 corresponds to the Eastern time zone. In this case, user device 120 determines that it is currently located in the Eastern time zone.

User device 120 may then use this information along with UTC time to determine the actual local time (act 670). For example, user device 120 may receive UTC information at periodic intervals from NOC 130. User device 120 may then apply the local time zone information to the UTC to determine the actual local time at user device 120. For example, assume that user device 120 receives UTC information indicating that the UTC time is 10:00 A.M. If user device 120 is in the Eastern time zone, user device 120 determines that the local time is 5:00 A.M. (i.e., UTC minus five hours). User device 120 may then use the local time for applications executed by user device 120 that require this information.

For example, suppose that a particular customer application implemented via system 100 reminds patients when to take particular medications. In this case, a party at a central location may enter time information regarding when a subscriber associated with a user device 120 is supposed to take a particular medicine, such as 8:00 A.M. The party entering the information may be located in any particular time zone and may merely enter the time (e.g., 8:00 A.M.) at which a subscriber is to take the medicine. NOC 130 may then transmit the reminder information via network 110. The destination user device 120 receives the reminder information and may determine its local time. User device 120 may then send an alert (e.g., beep, vibrate, etc.) and provide a message to the subscriber via user device 120 when its local time, 8:00 A.M. in this example, is equal to the time transmitted by NOC 130. In this manner, data may be entered at a central location without worrying about where (i.e., what time zone) the subscriber associated with the user device 120 may be located.

### CONCLUSION

In this disclosure, there is shown and described only the preferred embodiments of the invention, but, as aforementioned, it is to be understood that the invention is capable of use in various other combinations and environments and is capable of changes or modifications within the scope of the inventive concept as expressed herein.

For example, implementations consistent with the invention have been described with the example of generating local time information based on information in a synchronization signal. In alternative implementations, other fields may be configured to transmit information that may be used for the dual purpose of conveying their normal information and conveying information that may be mapped to identify local time information.

In addition, implementations consistent with the invention have been described with the example of a network operations center transmitting signals to various transmitters in a wireless network. In other implementations, a central network operations center may not be used and each transmitter may perform acts described above as being performed by a central network operations center. Lastly, a series of acts has been described with respect to FIG. 6. The order of the acts may be varied in other implementations consistent with the invention. Moreover, non-dependent acts may be performed in parallel.

No element, act, or instruction used in the description of the present application should be construed as critical or essential to the invention unless explicitly described as such. Also, as used herein, the article “a” is intended to include one or more items. Where only one item is intended, the term “one” or similar language is used. Further, the phrase “based on” is intended to mean “based, at least in part, on” unless explicitly stated otherwise.

The scope of the invention is defined by the claims and their equivalents.

1. A method for providing time information to user devices via a wireless network, comprising:
configuring a plurality of transmitters in the wireless network such that a synchronization frame transmitted by each of the plurality of transmitters may be used by the user devices to identify time zone information; and
transmitting, by each of the plurality of transmitters, the synchronization frame via the wireless network.

2. The method of claim 1, wherein the synchronization frame includes a B bit field.

3. The method of claim 2, wherein the B bit field includes color code information that may be used by a user device to identify a time zone in which the user device is located.

4. The method of claim 1, wherein the wireless network comprises a ReFLEX-based network.

5. The method of claim 1, further comprising:
receiving, at a user device, the synchronization frame;
decoding a B bit field in the synchronization frame; and
determining, at the user device, local time using the decoded B bit field.

6. The method of claim 5, wherein the determining comprises:
determining a color code index based on the decoded B bit field, and
determining local time based on the color code index.

7. The method of claim 1, wherein the configuring comprises:
configured each of the plurality of transmitters in a particular time zone to transmit color code information corresponding to a color code index within a predetermined range.

8. A system, comprising:
a plurality of transmitters, each of the plurality of transmitters configured to:
insert information in a synchronization frame, the information corresponding to a time zone associated with the respective transmitter, and
transmit the synchronization frame via a wireless network.

9. The system of claim 8, further comprising:
a network operations center, the network operations center configured to transmit color code information to each of the plurality of transmitters.

10. The system of claim 9, wherein each of the plurality of transmitters is further configured to:
receive the color code information from the network operations center.

11. The system of claim 8, wherein each of the plurality of transmitters is configured to communicate in accordance with the ReFLEX protocol.

12. The system of claim 8, further comprising:
a plurality of user devices, each of the plurality of user devices configured to:
receive the synchronization frame from one of the plurality of transmitters, and
determine a time zone in which the respective user device is located based on the information in the synchronization frame.

13. The system of claim 12, wherein when determining the time zone, each of the plurality of user devices is configured to:
identify an index based on the information in the synchronization frame, and
determine the time zone based on the index.

14. The system of claim 12, wherein each of the plurality of user devices is further configured to:
receive UTC time information at predetermined intervals, and
determined local time based on the UTC time and the determined time zone.

15. A system, comprising:
means for providing time zone information to a user device via a synchronization frame; and
means for transmitting the synchronization frame to the user device via a wireless network.

16. The system of claim 15, wherein the means for providing comprises:
means for assigning color code information to each of a plurality of transmitters based on a time zone in which the respective transmitter is located, and
means for inserting the color code information in the synchronization frame.

17. A device, comprising:
a receiver configured to receive radio frequency (RF) signals from a transmitter, the RF signals including a synchronization signal; and
logic configured to:
decode the synchronization signal, and
identify a time zone in which the device is located based on the decoded synchronization signal.

18. The device of claim 17, wherein the device is configured to communicate in accordance with the ReFLEX protocol and time zone information is included in a B bit field of the synchronization signal.

19. The device of claim 17, wherein when identifying a time zone, the logic is configured to:
identify color code information in the synchronization signal, and
use the color code information to identify the time zone.

20. The device of claim 17, wherein the logic is further configured to:
determine a local time based on the identified time zone.

21. A method for providing time information to user devices via a wireless network, comprising:
configuring each of a plurality of transmitters to transmit identification information based on a time zone in which each respective transmitter is located; and
transmitting a frame including the identification information from each of the plurality of transmitters via the wireless network.

22. The method of claim 21, wherein the frame comprises a synchronization frame and the identification information comprises color code information.

23. The method of claim 21, further comprising:
receiving, at a user device, the frame;
decoding, at the user device, the frame; and
identifying, at the user device, time zone information based on the decoded frame.

24. The method of claim 23, further comprising:
receiving, at the user device, universal time information; and
determining local time, at the user device, based on the identified time zone information and the received universal time information.

25. The method of claim 21, wherein the configuring comprises:
assigning to each of the plurality of transmitters in a particular time zone a color code corresponding to a color code index within a predetermined range.
